(19) United States
(12) Patent Application Publication
(10) Pub. No.: US 2025/0309456 A1
(43) Pub. Date: Oct. 2, 2025

(54) TRACTION BATTERY INSULATOR ASSEMBLY WITH ENCAPSULATED STRUCTURAL BODY

(71) Applicant: FORD GLOBAL TECHNOLOGIES, LLC, Dearborn, MI (US)

(72) Inventors: Kimberley King, Northville, MI (US); Marc Bronzetti, Berkley, MI (US); Daniel Paul Roberts, Livonia, MI (US)

(21) Appl. No.: 18/617,044

(22) Filed: Mar. 26, 2024

(51) Int. Cl. H01M 50/293; B60L 50/60; H01M 10/658; H01M 50/209

(52) U.S. Cl. CPC H01M 50/293; B60L 50/60; H01M 10/658; H01M 50/209; H01M 2220/20

(57) ABSTRACT

A traction battery assembly includes a plurality of battery cells arranged in a linear array, a substrate supporting the array, and an insulator assembly. The insulator assembly has outer compressible layers, at least one thermal insulation layer, and a metal layer. The metal layer includes a metal plate encapsulated in a dielectric material such that all surfaces of the metal plate are covered by the dielectric material, wherein the layers are secured to each other to form a unitary stack with the metal layer being disposed against the at least one thermal insulation layer and with the metal layer, the at least one thermal insulation layer is disposed between the outer layers, and the insulator assembly is disposed between an adjacent pair of the battery cells and is received on the substrate such that a portion of the dielectric material is between the substrate and the metal plate.

### TECHNICAL FIELD

The present disclosure relates to traction battery assemblies for motor vehicles, and more specifically to insulator assemblies disposed in the battery array.

### BACKGROUND

Vehicles such as battery-electric vehicles and hybrid-electric vehicles contain a traction battery assembly to act as an energy source for the vehicle. The traction battery may include components and systems to assist in managing vehicle performance and operations. The traction battery may also include high-voltage components, and may include an air or liquid thermal-management system to control the temperature of the battery.

### SUMMARY

According to one embodiment, a traction battery assembly includes a plurality of battery cells arranged in a linear array, a substrate supporting the array, and an insulator assembly. The insulator assembly has outer compressible layers, at least one thermal insulation layer, and a metal layer. The metal layer includes a metal plate encapsulated in a dielectric material such that all surfaces of the metal plate are covered by the dielectric material, wherein the layers are secured to each other to form a unitary stack with the metal layer being disposed against the at least one thermal insulation layer and with the metal layer, the at least one thermal insulation layer is disposed between the outer layers, and the insulator assembly is disposed between an adjacent pair of the battery cells and is received on the substrate such that a portion of the dielectric material is between the substrate and the metal plate.

According to another embodiment, a traction battery assembly including a substrate, an array of battery cells disposed on the substrate, and an insulator assembly. The insulator assembly includes a stack of: first and second outer compressible planar bodies, first and second thermal insulation planar bodies disposed between the first and second outer bodies, and a planar structural body including a metal plate encapsulated in a dielectric material such that all surfaces of the metal plate are covered by the dielectric material. The structural body has a first side disposed against the first thermal insulation body and a second side disposed against the second thermal insulation body. The insulator assembly is disposed between an adjacent pair of the battery cells and is received on the substrate such that a portion of the dielectric material is between the substrate and the metal plate.

According to yet another embodiment, a method includes stacking a metal plate onto a first film of dielectric material, wherein the metal plate and the first film have a substantially same cross sectional area; trimming an entire perimeter of the metal plate to expose an edge portion of the first film, the edge portion completely circumscribing the perimeter of the metal plate; disposing a second film over the metal plate, the second film having a substantially same cross-sectional area as the first film; adhering the second film to the first film to fully encapsulate the metal plate forming a structural body; and stacking the structural body, first and second outer compressible bodies, and at least one thermal insulation body to form an insulator assembly.

### BRIEF DESCRIPTION OF THE DRAWINGS

FIG. 1 is a schematic diagram of an example hybrid vehicle.

FIG. 2 is a side view of a battery array.

FIG. 3 is an exploded view of an insulator assembly.

FIG. 4 is a perspective view of the insulator assembly.

FIG. 5 is a side view of the insulator assembly installed on a substrate of the battery assembly with other components of the battery array omitted for illustrative purposes.

FIG. 6 is diagrammatical view of a process for manufacturing a metal layer of the insulator assembly and for assembling the insulator assembly.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

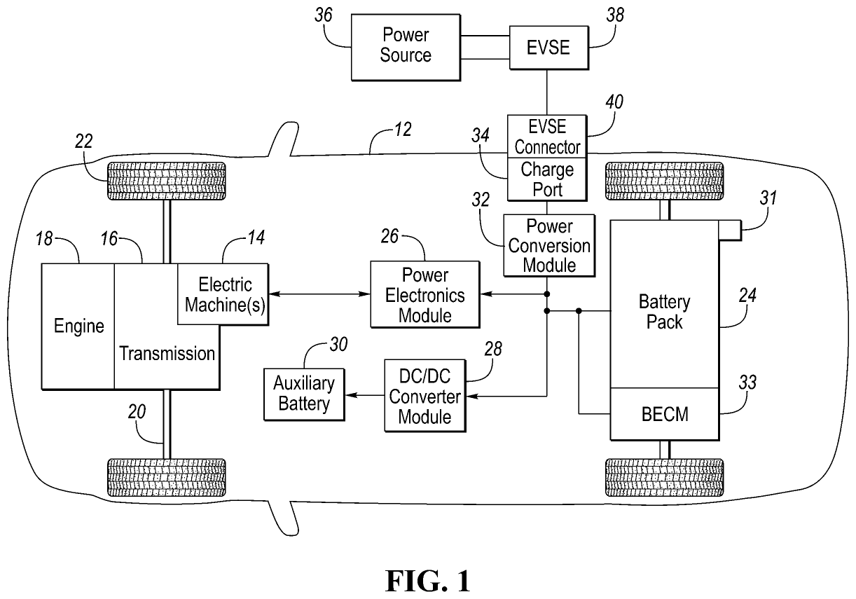

FIG. 1 depicts a schematic of a plug-in hybrid-electric vehicle (PHEV). Certain embodiments, however, may also be implemented within the context of non-plug-in hybrids and fully electric vehicles. The vehicle 12 includes one or more electric machines 14 mechanically connected to a hybrid transmission 16. The electric machines 14 may be capable of operating as a motor or a generator. In addition, the hybrid transmission 16 may be mechanically connected to an engine 18. The hybrid transmission 16 may also be mechanically connected to a drive shaft 20 that is mechanically connected to the wheels 22. The electric machines 14 can provide propulsion and deceleration capability when the engine 18 is turned on or off. The electric machines 14 also act as generators and can provide fuel economy benefits by recovering energy through regenerative braking. The electric machines 14 reduce pollutant emissions and increase fuel economy by reducing the work load of the engine 18.

A traction battery or battery pack 24 stores energy that can be used by the electric machines 14. The traction battery 24 typically provides a high voltage direct current (DC) output from one or more battery cell arrays, sometimes referred to as battery cell stacks, within the traction battery 24. The battery cell arrays include one or more battery cells.

The battery cells, such as a prismatic, pouch, cylindrical, or any other type of cell, convert stored chemical energy to electrical energy. The cells may include a housing, a positive electrode (cathode), and a negative electrode (anode). An electrolyte allows ions to move between the anode and cathode during discharge, and then return during recharge. Terminals may allow current to flow out of the cell for use by the vehicle.

Different battery pack configurations may be available to address individual vehicle variables including packaging constraints and power requirements. The battery cells may be thermally regulated with a thermal management system. Examples of thermal management systems include: air cooling systems, liquid cooling systems, and a combination of air and liquid systems.

The traction battery 24 may be electrically connected to one or more power electronics modules 26 through one or more contactors (not shown). The one or more contactors isolate the traction battery 24 from other components when opened and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24. The description herein is equally applicable to fully electric vehicles. In a fully electric vehicle, the hybrid transmission 16 may be a gear box connected to an electric machine 14 and the engine 18 is not present.

In addition to providing energy for propulsion, the traction battery 24 may provide energy for other vehicle electrical systems. A typical system may include a DC/DC converter module 28 that converts the high voltage DC output of the traction battery 24 to a low voltage DC supply that is compatible with other vehicle components. Other high-voltage loads, such as compressors and electric heaters, may be connected directly to the high-voltage supply without the use of a DC/DC converter module 28. In a typical vehicle, the low-voltage systems are electrically connected to an auxiliary battery 30, e.g., a 12-volt battery.

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by a charging station connected to an external power source 36. The external power source 36 may be electrically connected to electric vehicle supply equipment (EVSE) 38. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically connected to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34.

The various components discussed may have one or more associated controllers to control and monitor the operation of the components. The controllers may communicate via a serial bus, e.g., Controller Area Network (CAN), or via dedicated electrical conduits.

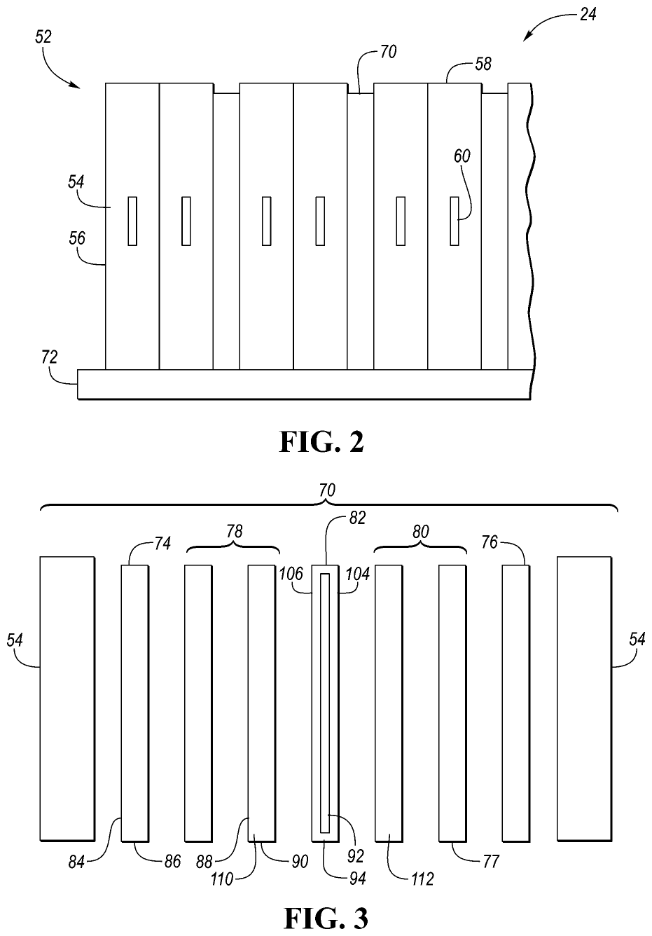

Referring to FIG. 2, the traction battery assembly 24 includes one or more battery arrays 52 each having a plurality of battery cells 54 arranged in stack. It is to be understood that the battery 24 may include one, two, three, four, or more arrays or stacks of battery cells and associated components.

Each of the battery cells 54 may have opposing major sides 56. The cells may be pouch cells, prismatic cells, or the like. Terminals 60 extend from the minor side(s) 58. Each cell 54 may have two terminals 60, e.g., a positive terminal and a negative terminal, with the positive and negative terminals extending from a different minor side 58. In other embodiments, the terminals may be located on a same minor side.

The array 52 may be held together by a pair of endplates and rails or other tension members (not shown) that connect the endplates to provide compression and retention of the cells. Each endplate may be adjacent to the major side 56 of the first or last cell. The arrays 52 may include additional support structure, insulators assemblies (described infra), or cooling features. The traction battery 24 may include more or less of the above-described battery arrays 52 depending upon the power requirements, packaging constraints, the desired electric range of the vehicle, and other factors.

The cells 54 in each array 52 may be wired in series, parallel, or a combination thereof. When more than one array is provided, the arrays may be connected in in series, parallel, or a combination thereof. The battery cells 54 may be electrically connected to each other with one or more busbars.

Each array includes one or more insulator assemblies 70 disposed between an adjacent pair of the cells 54. The insulator assemblies 70 may be interleaved with the battery cells 54 at regular intervals. In the illustrated embodiment, an insulator assembly 70 is provided every two cells. That is, the array 52 alternates two battery cells 54, one insulator assembly 70, two battery cells, etc. This, however, is merely one example embodiment. In some embodiments, three or more cells may be stacked together between each of the insulator assemblies 70. In other embodiments, the battery cells and the insulator assemblies 70 may alternate every other. The insulator assemblies 70 serve multiple purposes including thermal insulation, compressibility to account for tolerances in sizing, and to isolate the groups of cells from each other.

Each of the battery cell arrays 52, including the cells 54 and the insulator assembly 70, are supported by a substrate 72. The substrate 72 may be a tray of a battery housing or may be a cold plate or other cooling device.

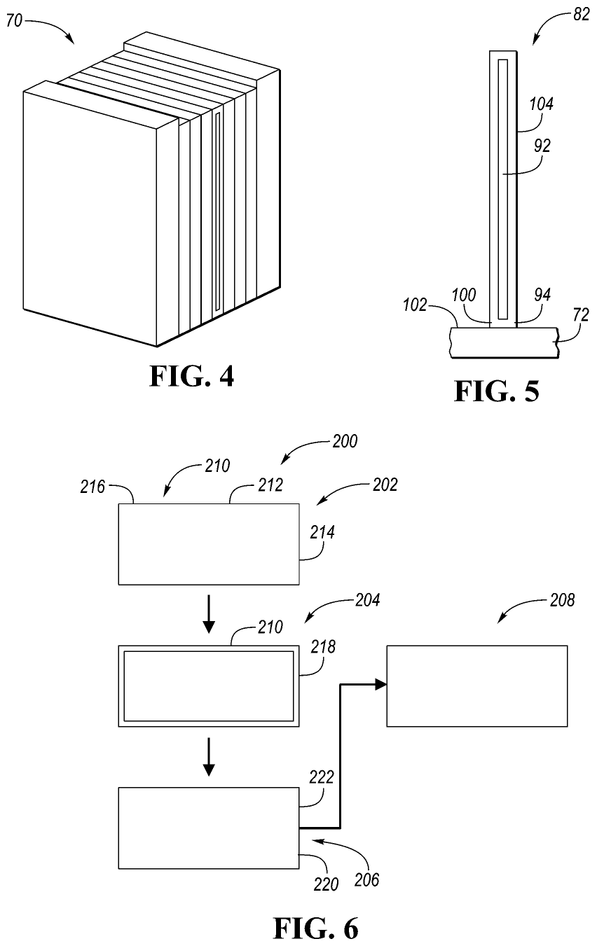

Referring to FIGS. 3 through 5, each insulator assembly 70 may be formed by a stack of a plurality of bodies or layers. In the illustrated embodiment, the insulator assembly 70 includes a first outer layer 74 and a second outer layer 76. The outer layers 74, 76 may be formed of compressible bodies having a planar shape that matches or substantially matches the size of the battery cells 54. For example, the outer layer 74, 76 may be thin or sheet-like rectangular prisms having major sides 84 that are much wider than a thickness of the minor sides 86. The compressible bodies may be formed of foam or other compressible material.

Between the first and second outer layers 74, 76 are at least one thermal insulation layer 77 and a structural layer, e.g., metal layer, 82. In the illustrated embodiment, a plurality of thermal insulation layers 77 are provided with at least one insulation layer on both sides of the metal layer 82. As shown in the example, a grouping of thermal insulation layers 78 are provided between the outer layer 74 and the metal layer 82, and another grouping of thermal insulation layers 80 is provided between the metal layer 82 and the outer layer 76. In the illustrated example, each grouping 78, 80 has two insulating layers, but additional or fewer layers may be provided in other embodiments. Each of the insulation layers 77 may be the same or different types of insulation layers may be provided within each of the groups 78, 80.

The thermal insulation layers reduce heat transfer between the adjacent cells. The thermal insulation layer 77 may be formed from mica, aerogel, or any other suitable insulator. Each thermal insulation layer 77 may be a planar sheet-like body having major sides 88 and minor sides 90.

The metal layer 82 may include a metal plate 92 encapsulated in a dielectric material 94 that fully surrounds the metal plate 82 such that all surface areas of the metal plate 92 are encapsulated. The metal layer may be steel (e.g., stainless or non-stainless), copper, aluminum, or other suitable metal. The metal layer 82 provides structural rigidity, puncture resistance, and heat spreading to the assembly 70. The inclusion of the metal layer 82 may result in a thinner assembly 72, increase the heat spreading ability of the metal plate 82, which allows for a reduction in the thickness or number of insulating layers. The dielectric layers may be a polymer such as a polymer including polyimide. Other examples include PET or other thermoplastics.

The fully encapsulated dielectric material 94 may further reduce weight and thickness of the metal layer 82. This design may also allow for a thinner metal layer, e.g., 0.04 millimeters (mm) compared to 0.1 mm, thus reducing weight and thickness of the assembly 70. The fully encapsulated dielectric material 94 may also prevents direct contact with the metal and covers any rough edges or burrs formed on the metal during the manufacturing process.

The metal layer 82 has major sides 104 and minor sides 106 defined by the dielectric material 94. The metal layer 82 is sandwiched between the insulation layers 78 and 80 with the major side 88 of the insulation body 110 disposed against the major side 106 of the metal layer 82 and with the major side 88 of the insulation body 112 disposed against the other major side 106 of the metal layer 82.

The dielectric material 94 allows the metal layer 82 to be directly received on the substrate 72 with the bottom 100 disposed against a top of the substrate 102. The substrate 72 may be metal such as a metal tray or a metal cold plate (e.g., a liquid-cooled heat exchanger) and the dielectric material 94 electrically isolates the metal layer 82 from the substrate 72.

FIG. 6 illustrates an example manufacturing process 200 for producing the metal layer of the insulator assembly and assembling the stack. In a first step (not shown), a first film or sheet of a dielectric material 210 is cut to size. In the illustrated embodiment, the dielectric material 210 is cut into a rectangular shape having a length 212 and a width 214. In step 202, a metal plate 216 is stacked on top of the dielectric material 210. The metal plate 216 is substantially the same size as the dielectric material 210 having the same length 212 and the same width 214. That is, the metal plate 216 and the dielectric material 210 have a substantially same cross-sectional area. Used herein, “substantially” means within 3 percent.

In step 204, the metal plate 216 is trimmed around an entire perimeter to expose an edge portion 218 of the first film 210. The edge portion 218 completely circumscribes the perimeter of the metal plate 216.

In step 206, a second film of dielectric material 220 is disposed on top of the metal plate 216 to form a stack with the metal plate 216 sandwiched between the first and second films of dielectric material 210, 220. The second film 220 has the substantially the same length 212 and with 214 as the first film. That is, the first and second films have a substantially same cross-sectional area so that the edges 222 of the films align when stacked at operation 206. The edge portions 218, which are outside the perimeter of the metal plate 216 come together and form an area for adhering the first and second films to each other to fully encapsulate the metal plate 216. After step 206, a fully formed metal layer is produced.

In step 208, the fully formed metal layer is stacked with the other components of the insulator assembly, which are then all secured together to form the final insulator assembly that can be incorporated into a battery array. For example, in step 208, the metal layer is placed between first and second outer compressible bodies with at least one thermal insulation body between one of the compressible bodies and the metal layer. In another example, the metal layer is sandwiched between first and second insulation bodies which are bookended by first and second outer compressible bodies to form the stack of the insulator assembly.

All of these layers of the insulator assembly are joined to each other to form a cohesive unit. For example, adhesive or two-way tape may be applied between each of the various layers of the insulator assembly. Alternatively, the layers may be banded or otherwise secured with mechanical means.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery assembly comprising:
a plurality of battery cells arranged in a linear array;
a substrate supporting the array; and
an insulator assembly including:
outer compressible layers,
at least one thermal insulation layer, and
a metal layer including a metal plate encapsulated in a dielectric material such that all surfaces of the metal plate are covered by the dielectric material, wherein the layers are secured to each other to form a unitary stack with the metal layer being disposed against the at least one thermal insulation layer and with the metal layer, the at least one thermal insulation layer is disposed between the outer layers, and the insulator assembly is disposed between an adjacent pair of the battery cells and is received on the substrate such that a portion of the dielectric material is between the substrate and the metal plate.

2. The traction battery assembly of claim 1, wherein the insulator assembly further includes a second thermal insulation layer disposed against the metal layer opposite the at least one thermal insulation layer.

3. The traction battery assembly of claim 1, wherein the at least one thermal insulation layer is a plurality of thermal insulation layers disposed between the metal layer and one of the outer layers.

4. The traction battery assembly of claim 1, wherein the dielectric material is a polymer.

5. The traction battery assembly of claim 4, wherein the polymer includes polyimide.

6. The traction battery assembly of claim 1, wherein metal plate is steel.

7. The traction battery assembly of claim 1, wherein the insulator assembly is a plurality of insulator assemblies, and each of the plurality of insulator assemblies is disposed between an adjacent pair of the battery cells.

8. The traction battery assembly of claim 1, wherein the substrate is a tray of a battery housing.

9. The traction battery assembly of claim 1, wherein the substrate is a cold plate.

10. The traction battery assembly of claim 1, wherein the metal layer is secured to the at least one thermal insulation layer by adhesive.

11. A traction battery assembly comprising:
a substrate;
an array of battery cells disposed on the substrate; and
an insulator assembly including a stack of:
first and second outer compressible planar bodies,
first and second thermal insulation planar bodies disposed between the first and second outer bodies, and
a planar structural body including a metal plate encapsulated in a dielectric material such that all surfaces of the metal plate are covered by the dielectric material, wherein the structural body has a first side disposed against the first thermal insulation body and a second side disposed against the second thermal insulation body, and the insulator assembly is disposed between an adjacent pair of the battery cells and is received on the substrate such that a portion of the dielectric material is between the substrate and the metal plate.

12. The traction battery assembly of claim 11, wherein the structural body is joined to the first and second thermal insulation bodies.

13. The traction battery assembly of claim 11, wherein the insulator assembly further includes a third thermal insulation planar body joined to the first outer body and disposed between the first insulation planar body and the first outer body.

14. The traction battery assembly of claim 11, wherein the compressible planar bodies are foam bodies.

15. The traction battery assembly of claim 14, wherein the thermal insulation planar bodies are formed of mica or aerogel.

16. The traction battery assembly of claim 11, wherein the dielectric material is a polymer.

17. A method comprising:
stacking a metal plate onto a first film of dielectric material, wherein the metal plate and the first film have a substantially same cross sectional area;
trimming an entire perimeter of the metal plate to expose an edge portion of the first film, the edge portion completely circumscribing the perimeter of the metal plate;
disposing a second film over the metal plate, the second film having a substantially same cross-sectional area as the first film;
adhering the second film to the first film to fully encapsulate the metal plate forming a structural body; and
stacking the structural body, first and second outer compressible bodies, and at least one thermal insulation body to form an insulator assembly.

18. The method of claim 17 further comprising:
assembling a battery array by arranging battery cells in an array and placing the insulator assembly between an adjacent pair of the battery cells.

19. The method of claim 17, wherein the first and second films are of a same material.

20. The method of claim 17, wherein the first and second films include polyimide.
